(19) United States
(12) Patent Application Publication
(10) Pub. No.: US 2007/0053274 A1
(43) Pub. Date: Mar. 8, 2007

(54) Compatible optical pickup and optical recording and/or reproducing apparatus employing the same

(75) Inventors: Jang-hoon Yoo, Seoul (KR); Soo-han Park, Yongin-si (KR); Young-man Ahn, Suwon-si (KR); Tae-kyung Kim, Seoul (KR); Yong-han Yoon, Suwon-si (KR); Young-sun Jeon, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/514,253

(22) Filed: Sep. 1, 2006

(30) Foreign Application Priority Data
Sep. 3, 2005 (KR) 2005-82004

(51) Int. Cl. G11B 7/135

(52) U.S. Cl. 369/112.16

(57) ABSTRACT

An optical pickup and an optical recording and/or reproducing apparatus include a light source which emits light having a first wavelength, an objective lens that focuses incident light on an information storage medium and is optimized for a first information storage medium of a predetermined standard, a polarization changer which changes the light with the first wavelength incident from the light source into light beams with first and second polarizations that are orthogonal to each other, a polarization hologram element which has a varying refractive power according to the polarization of the light with the first wavelength that passes through the polarization changer, a photodetector which receives light after the light has been emitted from the light source, focused on the information storage medium by the objective lens, and reflected by the information storage medium, and an optical path changer which guides the light reflected by the information storage medium toward the photodetector, wherein the optical pickup can compatibly adopt the first information storage medium and a second information storage medium which has a different thickness from the first information storage medium.

### CROSS-REFERENCE TO RELATED APPLICATIONS

This application claims the benefit of Korean Patent Application No. 2005-82004, filed on Sep. 3, 2005, in the Korean Intellectual Property Office, the disclosure of which is incorporated herein by reference.

### BACKGROUND OF THE INVENTION

1. Field of the Invention

Aspects of the present invention relate to an optical pickup and an optical recording and/or reproducing apparatus employing the same, and more particularly, to a compatible optical pickup which is compatible with a plurality of information storage medium standards and uses only one objective lens, and an optical recording and/or reproducing apparatus employing the optical pickup.

2. Description of the Related Art

Compact discs (CDs) and digital versatile discs (DVDs) are widely used nowadays, and blu-ray discs (BDs) and high-definition digital versatile discs (HD DVDs) are being released on the market.

New optical recording media such as BDs and HD DVDs have been developed to increase recording density. A light source which emits light with a short wavelength, and an objective lens with a high numerical aperture (NA), must both be used to read these high-density formats. A DVD standard uses a light source with a wavelength of 650 nm and an objective lens with an NA of 0.6. Accordingly, to increase the recording density, a light source which emits blue light with a wavelength of 400 to 408 nm, and an objective lens with an NA of 0.65 to 0.85, should be used. A BD disc has a thickness (i.e., an interval between a light incident plane and an information storage surface, corresponding to the thickness of a protection layer in this case) of approximately 0.1 mm, requires an objective lens with an NA of 0.85, and requires a light source with a wavelength of approximately 405 nm. The BD has a recording capacity of approximately 25 GB. Furthermore, an HD DVD standard uses a light source with a wavelength identical to that of the BD standard, an objective lens with an NA of 0.65, and a substrate with a thickness of approximately 0.6 mm, to have a recording capacity of approximately 15 GB.

Therefore, an apparatus compatible with these two optical disc standards, BD and HD DVD, is needed.

DVD standards, such as DVD-RAM and DVD±RW standards, use light sources with similar wavelengths, objective lenses with similar NAs, and optical disc substrates with similar thicknesses. In these standards, only the track pitch or the optical disc structure is different. Accordingly, since the operation of condensing light emitted from a light source onto an optical disc is almost the same regardless of which of these older optical disc standards is employed, people have designed a method of performing focusing and tracking of DVDS which is compatible with various track pitches.

However, the thicknesses of optical discs are different in the case of next-generation DVD standards, such as the BD and HD DVD standards. This difference in the thicknesses of the optical disks generates severe spherical aberration. Accordingly, it is necessary to compensate for the spherical aberration.

To compensate for the spherical aberration caused by the difference in thickness of these next-generation optical discs when one light source is used, a method using two objective lenses has been suggested.

U.S. Pat. No. 5,892,749 discloses an optical pickup using two fixed objective lenses. However, the optical pickup disclosed in the '749 patent uses a large number of optical elements, and is harder to adjust, because an adjustment of an optic axis using two fixed objective lenses is more difficult than an adjustment of an optical pickup having only a single objective lens.

### SUMMARY OF THE INVENTION

Aspects of the present invention provide a compatible optical pickup which is compatible with a plurality of optical information storage media having different recording densities by using one objective lens, a polarization changer that changes the polarization of incident light, and a polarization hologram that selectively changes a refractive power according to the polarization of incident light, and an optical recording and/or reproducing apparatus employing the optical pickup.

According to an aspect of the present invention, there is provided a compatible optical pickup including a light source which emits light with a first wavelength, an objective lens optimized for a first information storage medium of a predetermined standard that focuses incident light on an information storage medium, a polarization changer which changes the light with the first wavelength incident from the light source into light beams with first and second polarizations that are orthogonal to each other, a polarization hologram element having a varying refractive power according to the polarization of the light with the first wavelength that passes through the polarization changer, a photodetector which receives light that is emitted from the light source, focused on the information storage medium by the objective lens, and reflected by the information storage medium, and an optical path changer which guides the light reflected by the information storage medium toward the photodetector, wherein the optical pickup can compatibly adopt the first information storage medium and a second information storage medium having a different thickness from the first information storage medium.

The polarization changer may be a half wave plate with respect to the light which is emitted from the light source.

The polarization changer may be disposed between the optical path changer and the objective lens.

The optical path changer may be a polarization beam splitter.

The polarization hologram element may have a polarization hologram area that directly transmits the light with the first polarization to the objective lens, which focuses the light with the first polarization onto the first information storage medium, and refracts the light with the second polarization to the objective lens, which focuses the light with the second polarization onto the second information storage medium.

The polarization hologram area may be formed so that, when the light with the other polarization refracted therefrom is incident on the objective lens, an effective numerical aperture of the objective lens is a numerical aperture required by the standard of the second information storage medium.

The light source may be a light source which emits blue light, the first information storage medium may be a blu-ray disc (BD), and the second information storage medium may be a high-definition digital versatile disc (HD DVD).

The polarization changer may be fixed so that the optic axis of the polarization changer can range from 0 to 45 degrees or from 45 to 90 degrees with respect to the polarization direction of the light incident from the light source, and the polarization changer may change the polarization of the light with the first wavelength incident from the light source into light beams with first and second polarizations which are orthogonal to each other.

The optical pickup may further include a low density optical system which emits light suitable for a third information storage medium to compatibly utilize the third information storage medium which has a lower recording density than the first and second information storage media, the low density optical system receiving light reflected by the third information storage medium, and an optical path coupler which couples an optical path of light emitted from the low density optical system to an optical path of the light with the first wavelength, wherein the optical pickup can compatibly utilize the first, second, and third information storage media, and the third information storage medium is at least one of a digital versatile disc (DVD) and/or a compact disc (CD).

The optical pickup may further include an optical element that is interposed between the low density optical system and the objective lens, and which achieves an effective numerical aperture suitable for the third information storage medium.

The optical pickup may further include a driving unit which drives the polarization changer, wherein the driving unit drives the polarization changer so that the optic axis of the polarization changer is at an equal angle to or orthogonal to the polarization direction of the light incident from the light source. The optic axis may also be at an angle θ satisfying the following formula to, at an angle of 45 degrees to, or at an angle of 135 degrees to the polarization direction of the light incident from the light source. The optic axis may also be at an angle θ with respect to the polarization direction of the light incident from the light source according to the following formula:
0°<θ<45° or 45°<θ<90°.

The optical pickup may further include a quarter wave plate with respect to the light with the first wavelength disposed on an optical path between the polarization changer and the polarization hologram element.

According to another aspect of the present invention, there is provided an optical recording and/or reproducing apparatus including an optical pickup which moves in a radial direction of an information storage medium and records or reproduces information on the information storage medium, and a control unit which controls the optical pickup.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an optical pickup according to an embodiment of the present invention;

FIG. 2 is a plan view of a polarization hologram element of the optical pickup of FIG. 1 according to an embodiment of the present invention;

FIG. 3 illustrates a change in the polarization of light in the optical pickup of FIG. 1 when a blu-ray disc (BD), which requires a high numerical aperture (NA), for example, an NA of 0.85, is reproduced;

FIG. 4 illustrates a change in the polarization of light in the optical pickup of FIG. 1 when a high-definition digital versatile disc (HD DVD), which requires the same wavelength as a BD and a lower NA than a BD, for example, an NA of 0.65, is reproduced;

FIG. 5 illustrates an optical pickup according to another embodiment of the present invention;

FIG. 6 illustrates a change in the polarization of light in the optical pickup of FIG. 5 when a BD is used, wherein a polarization changer transmits light incident from a light source without changing the polarization of the light, and the fast or slow axis of a quarter wave plate makes an angle of 45 degrees or 135 degrees with respect to the polarization direction of the light incident on the polarization changer from the light source;

FIG. 7 illustrates a change in the polarization of light in the optical pickup of FIG. 5 when an HD DVD is used, wherein the optic axis of a polarization changer makes an angle θ, for example, an angle of 22.5 degrees, with respect to the polarization direction of light incident from the light source, and the fast or slow axis of a quarter wave plate makes an angle of 45 degrees or 135 degrees with respect to the polarization direction of the light incident from the light source on the polarization changer; and

FIG. 8 illustrates an optical recording and/or reproducing apparatus employing an optical pickup according to aspects of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

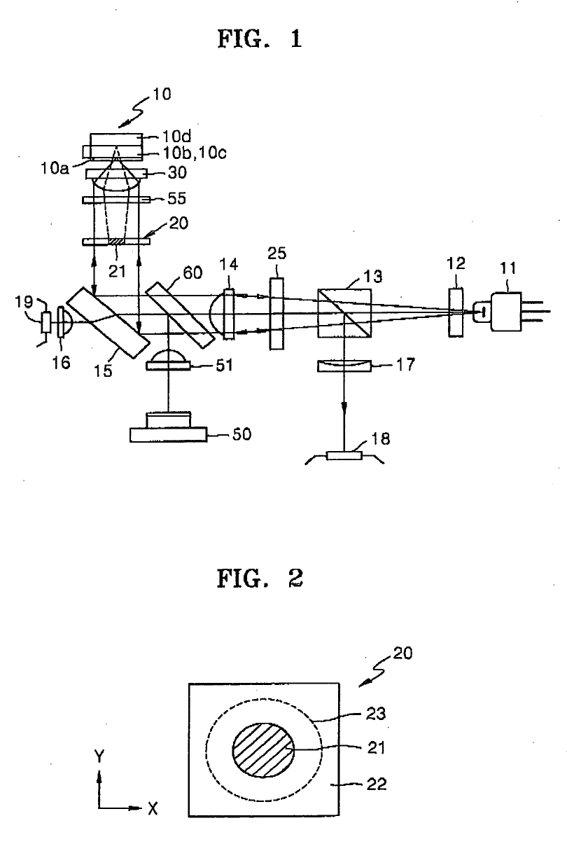

FIG. 1 illustrates an optical pickup, also known as an optical system, that is compatible with a plurality of information storage medium standards, according to an embodiment of the present invention.

Referring to FIG. 1, the optical pickup includes a light source 11, an objective lens 30 which focuses incident light on an information storage medium 10, the objective lens 30 being suitable for a first information storage medium of a predetermined standard, for example, a blu-ray disc (BD) 10a, a polarization changer 25 which changes the polarization of light having a first wavelength incident from the light source 11 into first and second polarizations that are orthogonal to each other, a polarization hologram element 20 which selectively changes a refractive power according to the polarization of the light which passes through the polarization changer 25, a photodetector 18 which receives part of the light having the first wavelength, and an optical path changer which guides the light reflected by the information storage medium 10 toward the photodetector 18. The light having the first wavelength is emitted from the light source 11, focused on the information storage medium 10 by the objective lens 30, and reflected by the information storage medium 10. The optical pickup is compatible with a first information storage medium, such as a BD 10a, and also with a second information storage medium, such as a high-definition digital versatile disc (HD DVD) 10b, which has a different thickness from the first information storage medium.

The light source 11 may be a light source which emits blue light. The first information storage medium may be the BD 10a, and the second information storage medium may be the HD DVD 10b. The light source 11 may emit blue light with a first wavelength, for example, a wavelength of approximately 400-408 nm, which can be used for both the BD 10a and the HD DVD 10b. The BD 10a has a thickness of approximately 0.1 mm, and the HD DVD 10b has a thickness of approximately 0.6 mm. The light source 11 may be a semiconductor laser, but may also be other kinds of light sources.

The objective lens 30 focuses incident light on the information storage medium 10. The objective lens 30 may be optimized for the BD 10a. In other words, when blue light with a wavelength of approximately 400 nm is incident, the objective lens 30 may form a light spot optimized for the 0.1 mm thick BD 10a with an effective numerical aperture (NA) of approximately 0.85.

The optical path changer may be disposed on an optical path between the light source 11 and the polarization changer 25. The optical path changer may be a polarization-selective optical path changer, for example, the polarization beam splitter 13, although other types of optical path changers may be used in accordance with embodiments of the present invention.

The polarization beam splitter 13 selectively transmits or reflects incident light according to the polarization of the light emitted from the light source 11. When the light source 11 is a semiconductor laser, since light emitted from a semiconductor laser is primarily first linearly polarized light, for example, P-polarized light, the P-polarized light incident from the light source 11 is transmitted through the polarization beam splitter 13 to the polarization changer 25. If the light source 11 transmits first linearly polarized light, then second linearly polarized light, for example, S-polarized light, which is orthogonal to the first linearly polarized light, is reflected from the information storage medium 10, and is then reflected by the polarization beam splitter 13 to the photodetector 18. Alternatively, S-polarized light may be emitted from the light source 11, in which case the polarization beam splitter 13 may transmit S-polarized light and reflect P-polarized light in the same way. The light source 11 and the photodetector 18 may be adjusted to change which type of polarized light emitted from the light source 11 is transmitted and reflected through the polarization beam splitter 13.

When the optical path changer is the polarization beam splitter 13, the polarization changer 25 may be disposed between the polarization beam splitter 13 and the objective lens 30, although the polarization changer 25 may also be disposed in other locations as well.

When the first objective lens 30 is optimized for the BD 10a, which has a thickness of 0.1 mm, the polarization changer 25 and the polarization hologram element 20 may be configured as follows in order to make the first objective lens 30 compatible with the HD DVD 10b, which has a different thickness and requires a different NA from the BD 10a.

The polarization changer 25 changes the polarization of the light having the first wavelength into first and second polarizations that are orthogonal to each other. The polarization changer 25 may be a half wave plate that changes the polarization of the light with the first wavelength, although the polarization changer 25 is not limited to being a half wave plate.

As is well known, when the optic axis, specifically, the fast axis, of the half wave plate makes an angle of 45 degrees with respect to the polarization direction of incident first linearly polarized light, the polarization of the light is rotated 90 degrees by the half wave plate to emit second linearly polarized light orthogonal to the first linearly polarized light. When the optic axis of the half wave plate makes an angle other than 45 degrees with respect to the polarization direction of incident linearly polarized light, the polarization of the incident first linearly polarized light, such as, for example, P-polarized light, is converted by the half wave plate into two linear polarizations, an S-polarization and a P-polarization, which are orthogonal to each other.

In the present embodiment, the polarization changer 25 has an optic axis, and is fixed so that the optic axis, i.e., the fast axis, of the polarization changer 25 can range from 0 to 45 degrees or from 45 to 90 degrees with respect to the polarization direction of the light with the first wavelength incident from the light source 11. In other words, the polarization changer 25 is disposed so that the optic axis of the polarization changer 25 forms an angle other than 45 degrees with respect to the polarization direction of the linearly polarized light incident from the light source 11. Thus, the polarization changer 25 can change the polarization of the linearly polarized light with the first wavelength incident from the light source 11 into first and second polarizations that are orthogonal to each other. The linearly polarized light may be S-polarized light or P-polarized light, and the first and second polarizations may be an S-polarization and a P-polarization, respectively, or vice versa.

The polarization changer 25 may be configured so that the optic axis of the polarization changer 25 forms an angle of 22.5 degrees with respect to the polarization direction of the light with the first wavelength incident from the light source 11. In this case, the incident S- or P-polarized light is converted by the polarization changer 25 into linearly polarized light with an S-polarization (50%) and a P-polarization (50%).

FIG. 2 is a plan view of the polarization hologram element 20 of the optical pickup of FIG. 1.

Referring to FIG. 2, the polarization hologram element 20 has a polarization hologram area 21 that directly transmits the light with one polarization of the first and second polarizations, which has been polarized through conversion by the polarization changer 25, and refracts the light with the other polarization. The polarization hologram area 21 may have a stepped or blazed holographic pattern formed thereon.

The light with the one polarization linearly transmitted through the polarization hologram area 21 is focused by the objective lens 30 on the BD 10a. The light with the other polarization refracted by the polarization hologram area 21 is focused by the objective lens 30 on the HD DVD 10b.

The polarization hologram area 21 may be formed to generate an effective NA of the objective lens 30 of approximately 0.65, which is the NA required by the HD DVD 10b standard, when the light with the other polarization refracted by the polarization hologram area 21 is incident on the objective lens 30. The polarization hologram area 21 may be formed to a predetermined size on a central portion of the polarization hologram element 20 in order to achieve an effective NA of 0.65. In FIG. 2, reference numeral 22 denotes a transparent area other than the polarization hologram area 21, and reference numeral 23 denotes an area corresponding to an effective NA of 0.85, which is an NA suitable for the BD 10a.

When the polarization hologram area 21 is formed to achieve the effective NA of the objective lens 30 required by the HD DVD 10b standard and the objective lens 30 is optimized for the BD 10a, and when the information storage medium 10 is the BD 10a, the light emitted from the light source is directly transmitted through the transparent area 22 and the polarization hologram area 21 of the polarization hologram element 20 and focused on the surface of the BD 10a

On the other hand, when the information storage medium 10 is the HD DVD 10b, the light emitted from the light source which is directly transmitted through the transparent area 22 and the polarization hologram area 21 of the polarization hologram element 20 cannot be focused on an information storage surface of the HD DVD 10b due to the difference in thickness between the BD 10a and the HD DVD 10b, and thus this light cannot be used with the HD DVD 10b. Only the light refracted by the polarization hologram area 21 of the polarization hologram element 20 is focused on the information storage surface of the HD DVD 10b.

Thus, the optical pickup according to this embodiment of the present invention can be compatibly used with both the BD 10a and the HD DVD 10b formats, using the polarization changer 25 and the polarization hologram element 20, even when the objective lens 30 is optimized for the BD 10a.

To compatibly read a third information storage medium with a lower recording density than the BD10a or the HD DVD 10b, the optical pickup may further include a low density optical system 50 that emits light suitable for the third information storage medium and receives light reflected by the third information storage medium, and an optical path coupler 60 which couples an optical path of light emitted from the low density optical system 50 to an optical path of the light with the first wavelength.

Additionally, the optical pickup according to aspects of the present invention may further include an optical element 55 that is disposed on an optical path between the low density optical system 50 and the objective lens 30, and which achieves an effective NA suitable for the third information storage medium to compatibly adopt low density information storage medium. Instead of the separately installed optical element 55, a hologram may be formed on a lens surface of the objective lens 30.

The optical pickup is compatible with the first, second, and third information storage media. The third information storage medium may be a digital versatile disc (DVD) 10c, or a compact disc (CD) 10d, but is not limited to these information storage media. In other words, the optical pickup according to aspects of the present invention is compatible with the BD 10a, the HD DVD 10b, the DVD 10c, the CD 10d, and other types of information storage media.

The low density optical system 50 may include a first optical module for the DVD 10c, a second optical module for the CD 10d, and a beam splitter that couples optical paths of light incident from the first and second optical modules in order to transmit the light along the same optical path and also guides light reflected by the information storage medium 10 toward the first and second optical modules. The low density optical system 50 may further include a first collimating lens 51 for the DVD 10c and the CD 10d. The first collimating lens 51 is interposed between the beam splitter and the optical path coupler 60 and collimates light incident from the first and second optical modules.

The first optical module may be a hologram optical module for the DVD 10c which includes a light source with a red wavelength, for example, a wavelength of approximately 650 nm. The second optical module may be a hologram optical module for the CD 10d which includes a light source with an infrared wavelength, for example, a wavelength of approximately 780 nm. Each of the hologram optical modules includes a light source, a photodetector which detects a signal, and a hologram that linearly transmits light emitted from the light source and diffracts light reflected by the information storage medium 10 into first order light, such that the first order light propagates toward the photodetector. The hologram optical module may further include a grating pattern that is formed onto the surface of a transparent member opposite to a surface on which the hologram is formed and divides incident light into three or more light beams to detect a tracking error signal using a three-beam method. Since the hologram optical module is well known in the art, a detailed description and views thereof will not be given.

The low density optical system 50 may be formed to be used for either the DVD 10c or the CD 10d.

The optical path coupler 60 transmits the light with the first wavelength incident from the light source 11 and reflects red light and/or infrared light incident from the low density optical system 50 to couple the optical path of the light with the first wavelength incident from the light source 11 to the optical path of the red light and/or infrared light incident from the low density optical system 50. The optical path coupler 60 may be a dichroic mirror, but is not limited to being a dichroic mirror.

The optical element 55 may be a diffraction optical element (DOE) or a liquid crystal element, but is not limited to being a DOE or a liquid crystal element.

When the optical element 55 is a DOE and the low density optical system 50 emits red light for the DVD 10c and infrared light for the CD 10d, the DOE transmits the light with the first wavelength, which is suitable for the BD 10a and the HD DVD 10b, and diffracts the red light suitable for the DVD 10c and the infrared light suitable for the CD 10d, in order to achieve effective NAs of approximately 0.6 and 0.45, respectively. The effective NAs can be adjusted by changing a refractive power of the diffraction caused by the DOE.

When the optical element 55 is a liquid crystal element, the liquid crystal element may be formed and driven to transmit the light with the first wavelength suitable for the BD 10a and the HD DVD 10b and selectively block the red light suitable for the DVD 10c and the infrared light suitable for the CD 10d by areas corresponding to effective NAs of approximately 0.6 and 0.45. The effective NAs can be adjusted by changing the NA size of a diaphragm. This NA size is obtained during the operation of the liquid crystal element.

Instead of including the first optical module for the DVD 10c and/or the second optical module for the CD 10d, the low density optical system 50 of the optical pickup according to aspects of the present invention may instead be a separation type optical system in which a light source and a photodetector are separated for compatible use of the DVD 10c and/or the CD 10d. The present invention is not limited to the present embodiment of the low density optical system 50, and the optical configuration of the low density optical system 50 of the optical pickup may be modified variously.

Since the low density optical system 50 used for the DVD 10c and the CD 10d is well known in the art, a detailed description and views of the low density optical system 50 will not be given.

The optical pickup according to aspects of the present invention may further include a second collimating lens 14 as shown in FIG. 1. The second collimating lens 14 is disposed on an optical path between the light source 11 and the objective lens 30 and collimates the divergent light emitted from the light source 11. The optical pickup may further include a grating 12 that is disposed in front of the light source 11 and divides the light with the first wavelength incident from the light source 11 into a plurality of light beams using a three-beam method to detect a tracking error signal. Referring to FIG. 1, the second collimating lens 14 is disposed between the polarization changer 25 and the optical path coupler 60.

The optical pickup may further include a reflecting mirror 15 that bends the optical path of light and a sensing lens 17 that focuses part of the light with the first wavelength, which is reflected by the information storage medium, onto the photodetector 18, to form a proper light spot for effective use. The sensing lens 17 may be an astigmatic lens that can detect a focusing error signal using an astigmatic method. These methods are well-known in the art, and therefore, more detailed descriptions are not included.

The reflecting mirror 15 may be formed to reflect most of the incident light and transmit the remaining part of the incident light. The optical pickup according to this embodiment may further include a monitoring photodetector 19 which is disposed behind the reflecting mirror 15 and monitors light output from the light source 11 and/or the light source of the low density optical system 50, and a condensing lens 16 which condenses light on the monitoring photodetector 19.

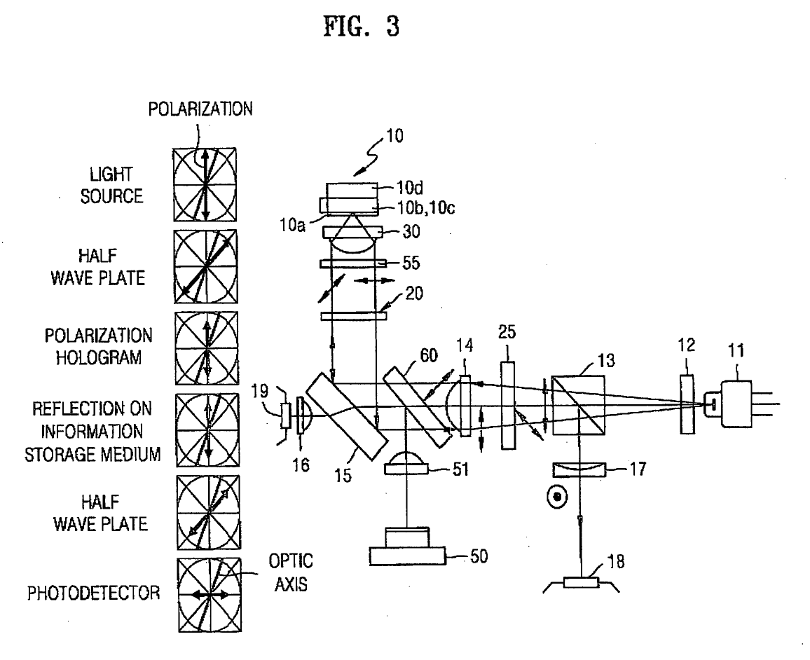

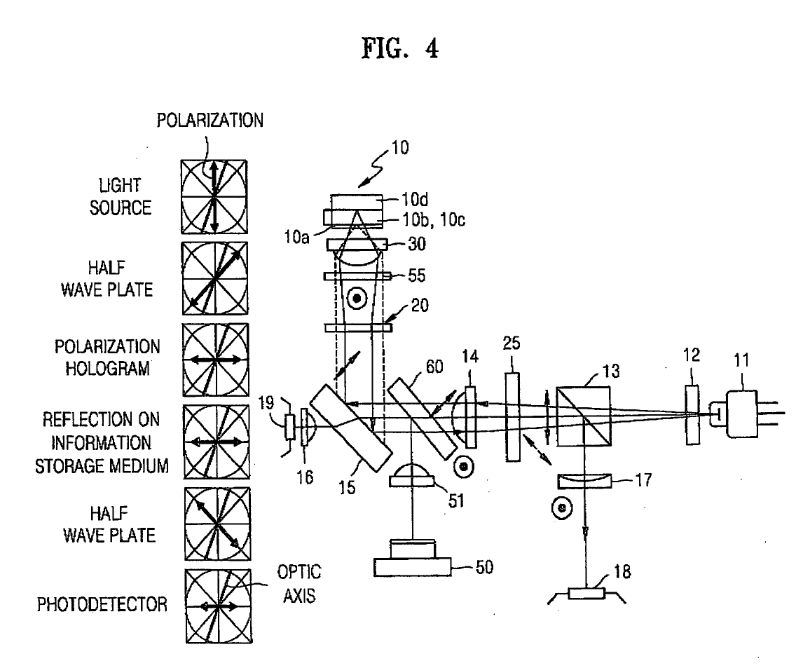

FIGS. 3 and 4 illustrate a change in the polarization of light when the optic axis of the polarization changer 25 is inclined 22.5 degrees with respect to the polarization direction of predetermined linearly polarized light which is emitted from the light source 11 and transmitted through the polarization beam splitter 13. FIG. 3 illustrates when a BD 10a is used and FIG. 4 illustrates when a HD DVD 10b is reproduced.

FIG. 3 illustrates a change in the polarization of light in the optical pickup of FIG. 1 when the BD 10a is reproduced, which requires an NA, for example, of approximately 0.85.

Light emitted from the light source 11 is transmitted through the polarization beam splitter 13, passes through the polarization changer 25, for example, the half wave plate with an optic axis inclined by 22.5 degrees so that the polarization state of the light is rotated by 45 degrees, and then is transmitted to the polarization hologram element 20. To rotate the polarization state of the light by 45 degrees, the optic axis of the polarization changer 25 should form a 22.5 degree angle with respect to the polarization direction of the incident light.

The 45 degree-linearly polarized light has P- and S-polarizations. When the light with the P-polarization is directly transmitted through the polarization hologram area 21 of the polarization hologram element 20, it does not experience refraction. As a result, the light with the P-polarization is focused on the BD 10a by the objective lens 30, which is optimized for the BD 10a. Here, light focused on the BD 10a includes the light with the P-polarization transmitted through the polarization hologram area 21 of the polarization hologram element 20, as well as light propagating outside the polarization hologram area 21.

A reproduction signal of the BD 10a is obtained from the focused light, and a signal light is reflected by the BD 10a. The reflected light is transmitted through the objective lens 30 again and the light with the P-polarization is transmitted through the polarization hologram element 20 to the polarization changer 25 along the same path as incident as shown in FIG. 3, without experiencing refraction. The polarization changer 25 rotates the P-polarized light by −45 degrees and then transmits the rotated light to the polarization beam splitter 13. The polarization beam splitter 13 reflects only the part of the light with an S-polarization to the photodetector 18 to detect a signal of the BD 10a.

The polarization change while the light passes through the respective elements is shown on the left side of FIG. 3. The length of an arrow represents the magnitude of polarized light. An optic axis shown on the left side of FIG. 3 represents the optic axis of the polarization changer 25.

FIG. 4 illustrates a change in the polarization of effective light when the HD DVD 10b, which uses the same wavelength as the BD 10a and a lower NA than the BD 10a, for example, an NA of approximately 0.65, is reproduced. Light emitted from the light source 11 is transmitted through the polarization beam splitter 13, and passes through the polarization changer 25 such that light with a P-polarization is rotated 45 degrees by the polarization changer 25. In order to rotate the polarization of light 45 degrees, the optic axis of the polarization changer 25 should form a 22.5 degree angle with respect to the polarization direction of incident light.

Since the 45-degree linearly polarized light has P- and S-polarizations, only the light with the S-polarization experiences refraction as it passes through the polarization hologram area 21 of the polarization hologram element 20 to be focused on the HD DVD 10b. Light focused on the HD DVD 10b includes only the light with the S-polarization passing through the polarization hologram area 21 of the polarization hologram element 20. The light with the P-polarization passing through the polarization hologram area 21 and light propagating outside the polarization hologram area 21 are not focused on the HD DVD 10b.

A reproduction signal of the HD DVD 10b is obtained from the focused light, and a signal light is reflected by the HD DVD 10b. The reflected light is transmitted through the objective lens 30, such that the refractive power of the light with the S-polarization is affected by the polarization hologram area 21 of the polarization hologram element 20. Then, the light with the S-polarization is transmitted to the polarization changer 25 along the same optical path as the incident light shown in FIG. 4. The polarization changer 25 rotates the light with the S-polarization by −45 degrees and then transmits the rotated light to the polarized beam splitter 13. The polarization beam splitter 13 reflects a part of the light with S-polarization to the photodetector 18 to detect a signal of the HD DVD 10b.

The polarization change while the light is transmitted through the respective elements is shown on the left side of FIG. 4. The length of an arrow represents the magnitude of polarized light. An optic axis shown on the left side of FIG. 4 represents the optic axis of the polarization changer 25.

As described above, since the optical pickup according to aspects of the present invention includes the polarization hologram element 20 which selectively produces a refractive power according to the polarization of light, the optical pickup is compatible with information storage media having different formats and thicknesses but which use the same wavelengths, such as the BD 10a and the HD DVD 10b. Also, since the optical pickup includes the low density optical system 50, the optical pickup is compatible with the BD 10a, the HD DVD 10b, the DVD 10c, the CD 10d, and other types of lower-density information storage media.

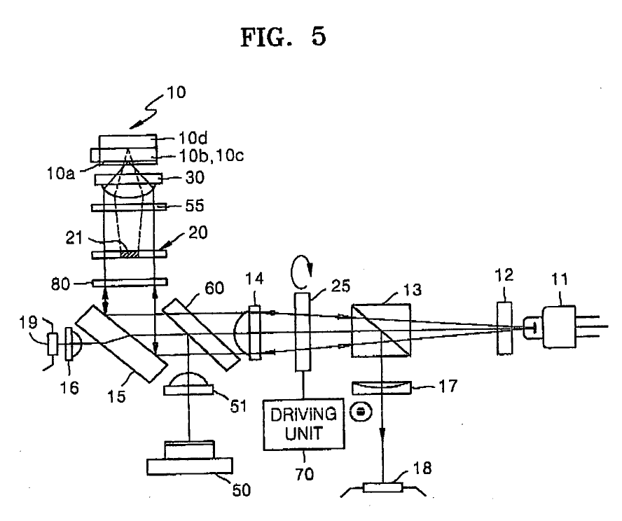

FIG. 5 illustrates an optical pickup according to another embodiment of the present invention. Unlike the optical pickup of FIG. 1, the optical pickup of FIG. 5 further includes a driving unit 70 that actively rotates the polarization changer 25. The elements illustrated in FIG. 5 are identical or similar in function to those of FIG. 1 and are given the same reference numerals as FIG. 1, so a detailed explanation of these elements is omitted.

Referring to FIG. 5, the driving unit 70 rotates the polarization changer 25 according to what kind of information storage medium is used, as well as whether the user is using the optical pickup in a recording mode or a reproduction mode. The optic axis of the polarization changer 25 is equal to, orthogonal to, or forms an angle of 45 degrees, 135 degrees, or θ to the polarization direction of the light having the first wavelength incident from the light source 11. The angle θ satisfies the inequality 0°<θ<45° or 45°<θ<90°. The angle θ of FIG. 1 corresponds to the angle formed between the optic axis of the polarization changer 25 of FIG. 1 and the polarization direction of the light with the first wavelength incident from the light source 11.

The optical pickup according to aspects of the present invention may further include a quarter wave plate 80 with respect to the wavelength of light emitted from the light source 11. The fast or slow axis of the quarter wave plate 80 may form an angle of 45 degrees or 135 degrees with respect to the polarization direction of the light that is incident from the light source 11 on the polarization changer 25. When the polarization changer 25 is driven to transmit the light incident from the light source 11 without changing the polarization of the light or rotating the polarization direction of the light by 90 degrees, the quarter wave plate 80 may turn the P-polarized light propagating from the light source 11 into circularly polarized light after the P-polarized light passes through the quarter wave plate 80.

When the polarization changer 25 is driven by the driving unit 70 so that the optic axis of the polarization changer 25 is equal to or orthogonal to the polarization direction of light incident from the light source 11, the light emitted from the light source 11 is transmitted through the polarization changer 25 without changing the polarization of the light emitted from the light source 11.

When the polarization changer 25 is driven by the driving unit 70 so that the optic axis of the polarization changer 25 forms an angle of 45 degrees or 135 degrees with respect to the polarization direction of the light incident from the light source 11, the polarization changer 25 rotates the polarization direction of the light by 90 degrees when the light incident from the light source 11 passes through the polarization changer 25.

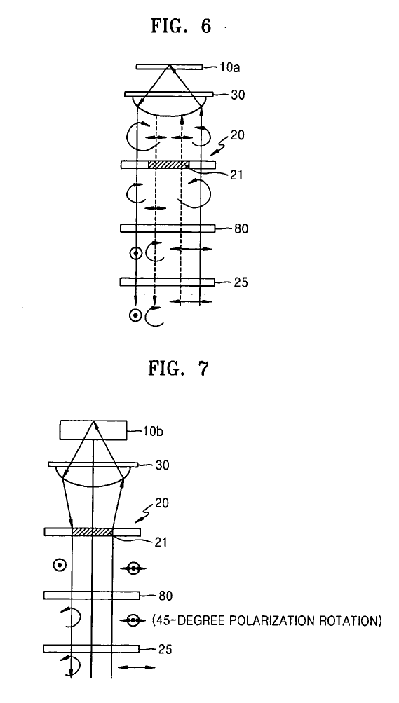

FIG. 6 illustrates the optical pickup of FIG. 5 when applied to the BD 10a, and specifically, illustrates a change in the polarization of light with respect to the BD 10a when the polarization changer 25 transmits the light emitted from the light source 11 without changing the polarization of the light and the fast or slow axis of the quarter wave plate 80 forms an angle of 45 degrees or 135 degrees with respect to the polarization direction of the light incident on the polarization changer 25 from the light source 11.

Referring to FIG. 6, light, for example, P-polarized light, passes through the quarter wave plate 80 to become first circularly polarized light. The first circularly polarized light may have an S-polarization (50%) and a P-polarization (50%). These different polarizations have a phase difference of 90 degrees and the same magnitude.

Accordingly, within the first circularly polarized light, the light with the P-polarization is directly transmitted through the polarization hologram area 21 and then focused on the BD 10a by the objective lens 30, and the light propagating outside the polarization hologram area 21 of the polarization hologram element 20 is also focused by the objective lens 30 on the BD 10b.

The first circularly polarized light is reflected by the BD 10a to become second circularly polarized light which is orthogonal to the first circularly polarized light.

The second circularly polarized light reflected by the BD 10a, along with the light having the P-polarization, are both transmitted through the polarization hologram element 20 to a position incident on the quarter wave plate 80, and then become S-polarized light and predetermined circularly polarized light, respectively, by the quarter wave plate 80, and finally are transmitted through the polarization changer 25 without a change in polarization.

As described with reference to FIG. 6, when the polarization changer 25 is disposed so that at least part of the light incident on the BD 10a can be circularly polarized light, then the optical pickup according to aspects of the present invention detects a high quality reproduction signal, improves reproduction performance, and forms a high quality light spot on the BD 10a, even if the BD 10a has a birefringence characteristic.

When the polarization changer 25 is driven so that the light transmitted through the polarization changer 25 has the S-polarization or the P-polarization shown in FIG. 6, if the HD DVD 10b format is used instead of the BD 10a format, only the light with the S-polarization refracted by the polarization hologram area 21 of the polarization hologram element 20 can be focused on the HD DVD 10b.

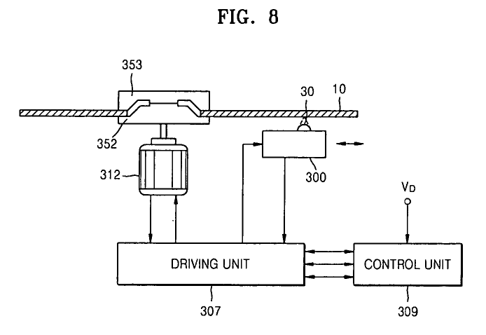

FIG. 7 illustrates the optical pickup of FIG. 5 when applied to the HD DVD 10b, and specifically, illustrates a change in the polarization of light with respect to the HD DVD 10b when the optic axis of the polarization changer 25 forms an angle of θ, for example, an angle of 22.5 degrees, with respect to the polarization direction of the light emitted from the light source 11 and the fast or slow axis of the quarter wave plate 80 forms an angle of 45 degrees or 135 degrees with respect to the polarization direction of the light incident on the polarization changer 25 from the light source 11.

Referring to FIG. 7, when the angle of θ is 22.5 degrees, P-polarized light passes through the polarization changer 25 such that the polarization direction of the light is rotated 45 degrees. Since the polarization direction of the P-polarized light, which has been rotated 45-degrees by the polarization changer 25, is equal to the fast or slow axis of the quarter wave plate 80, the rotated light can be transmitted through the quarter wave plate 80 without having its polarization changed.

Within the rotated light, only the light with an S-polarization is refracted by the polarization hologram area 21 of the polarization hologram element 20 before being focused on the HD DVD 10b. The light with the S-polarization is then reflected by the HD DVD 10b, refracted by the polarization hologram element 20 as it proceeds toward the quarter wave plate 80 along the same optical path as its original optical path, and becomes circularly polarized light by the quarter wave plate 80. The circularly polarized light is then transmitted through the polarization changer 25 without changing polarity.

When the polarization changer 25 is driven to rotate light 45-degrees which is transmitted through the polarization changer 25, as shown in FIG. 7, if the BD 10a is used instead of the HD DVD 10b, P-polarized light passing through the polarization hologram area 21 of the hologram element 20 is not refracted, and light propagating outside the polarization hologram area 21 to be polarized by 45 degrees is focused on the BD 10a.

When a user actively rotates the polarization changer 25 as described above, since part of the light incident on the information storage medium 10 can be turned into circularly polarized light, a high quality reproduction signal is detected and a high quality recording performance is achieved, even when the BD 10a has a birefringence characteristic.

Accordingly, the optical pickup according to another embodiment of the present invention controls an optical recording and/or reproducing apparatus to ensure an outstanding recording performance and detect a high quality reproduction signal by pivoting the polarization changer 25 according to the birefringence characteristic of the information storage medium adopted. The optical pickup according to another embodiment of the present invention allows the user to adjust the optical pickup so that the optic axis of the polarization changer 25 forms a proper angle with respect to the polarization direction of the light, depending on whether the user wants to use the optical pickup in a recording mode or a reproduction mode.

FIG. 8 illustrates an optical recording and/or reproducing apparatus employing an optical pickup according to various embodiments of the present invention.

Referring to FIG. 8, the optical recording and/or reproducing apparatus includes a spindle motor 312 which rotates the information storage medium 10, an optical pickup 300 which is movable in a radial direction of the information storage medium 10 and which reproduces and/or records information on the information storage medium 10, a driving unit 307 which drives the spindle motor 312 and the optical pickup 300, and a control unit 309 which controls the focus and tracking servos of the optical pickup 300. Reference numeral 352 denotes a turntable, and reference numeral 353 denotes a clamp which holds the information storage medium 10.

The optical pickup 300 may be any one of the optical pickups illustrated in FIGS. 1 and 5.

Light reflected by the information storage medium 10 is detected by the photodetector of the optical pickup 300 in order to be converted into an electrical signal, and the electrical signal is inputted to the control unit 309 through the driving unit 307. The driving unit 307 controls the rotational speed of the spindle motor 312, amplifies an input signal, and drives the optical pickup 300. The control unit 309 delivers a focus servo, a tracking servo and/or a tilting servo command, based on another signal inputted from the driving unit 307 to the driving unit 307, to enable the optical pickup 300 to perform focusing, tracking, and/or tilting operations. The optical recording and/or reproducing apparatus employing the optical pickup according to aspects of the present invention is compatible with the BD 10a, the HD DVD 10b, and at least one of either the DVD 10c or the CD 10d, and can ensure a high speed operation because only one objective lens 30 is used, compared with a conventional actuator which uses one lens holder and two objective lenses.

As described above, the optical pickup according to aspects of the present invention is compatible with the BD and the HD DVD using only one objective lens.

The optical pickup according to aspects of the present invention employs a polarization changer and a polarization hologram element to minimize the number of elements and easily realize a compatible objective lens.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical pickup which is compatible with a plurality of information storage medium standards, the optical pickup comprising:
a light source which emits light;
an objective lens which focuses the light emitted from the light source onto an information storage medium;
a polarization changer which changes the light into first and second light beams with first and second polarizations, respectively, which are orthogonal to each other;
a polarization hologram element which has a varying refractive power according to the polarization of the first and second light beams;
a photodetector which receives light after the light has been emitted from the light source, focused on the first information storage medium by the objective lens, and reflected by the information storage medium; and
an optical path changer which guides the light reflected by the information storage medium toward the photodetector, wherein the optical pickup is compatible with the first information storage medium and a second information storage medium which has a different thickness from the first information storage medium.

2. The optical pickup of claim 1, wherein the polarization changer is a half wave plate.

3. The optical pickup of claim 1, wherein the polarization changer is disposed between the optical path changer and the objective lens.

4. The optical pickup of claim 3, wherein the optical path changer is a polarization beam splitter.

5. The optical pickup of claim 2, wherein the polarization hologram element has a polarization hologram area which directly transmits the light beam with the first polarization to the objective lens so that the light beam with the first polarization is focused onto the first information storage medium, and refracts the light with the second polarization to the objective lens so that the light beam with the second polarization is focused onto the second information storage medium.

6. The optical pickup of claim 5, wherein the polarization hologram area is formed so that, when the light beam with the second polarization refracted from the polarization hologram area is transmitted to the objective lens, the polarization hologram area forms a numerical aperture of the objective lens to focus the light beam with the second polarization onto the second information storage medium.

7. The optical pickup of claim 6, wherein the light source emits blue light, the first information storage medium is a blu-ray disc, and the second information storage medium is a high-definition digital versatile disc.

8. The optical pickup of claim 1, wherein the polarization hologram element has a polarization hologram area which directly transmits the light beam with the first polarization to the objective lens so that the light beam with the first polarization is focused onto the first information storage medium, and refracts the light beam with the second polarization to the objective lens so that the light beam with the second polarization is focused onto the second information storage medium.

9. The optical pickup of claim 8, wherein the polarization hologram area is formed so that, when the light beam with the second polarization refracted from the polarization hologram area is transmitted to the objective lens, the polarization hologram area forms a numerical aperture which focuses the light beam with the second polarization onto the second information storage medium.

10. The optical pickup of claim 8, wherein the light source emits blue light, the first information storage medium is a blu-ray disc, and the second information storage medium is a high-definition digital versatile disc.

11. The optical pickup of claim 1, wherein the polarization changer is configured so that an optic axis of the polarization changer ranges from 0 to 45 degrees or from 45 to 90 degrees with respect to a polarization direction of the light emitted from the light source.

12. The optical pickup of claim 10, further comprising:
a low density optical system which emits light suitable for a third information storage medium which has a lower recording density than the first and second information storage media, the low density optical system receiving light reflected by the third information storage medium; and
an optical path coupler which couples an optical path of light emitted from the low density optical system to an optical path of the light emitted from the light source, wherein the optical pickup is compatible with the first, second, and third information storage media, and the third information storage medium is at least one of a digital versatile disc or a compact disc.

13. The optical pickup of claim 11, further comprising:
a low density optical system which emits light suitable for a third information storage medium which has a lower recording density than the first and second information storage media, the low density optical system receiving light reflected by the third information storage medium; and
an optical path coupler which couples an optical path of light emitted from the low density optical system to an optical path of the light emitted from the light source, wherein the optical pickup is compatible with the first, second, and third information storage media, and the third information storage medium is at least one of a digital versatile disc or a compact disc.

14. The optical pickup of claim 13, further comprising an optical element which is interposed between the low density optical system and the objective lens, and which focuses light emitted from the low density optical system onto the third information storage medium by creating a suitable numerical aperture.

15. The optical pickup of claim 1, further comprising a driving unit which drives the polarization changer so that an optic axis of the polarization changer is equal to or orthogonal to a polarization direction of the light emitted from the light source, or forms an angle with respect to the polarization direction of the light emitted from the light source of 45 degrees, 135 degrees, or an angle θ satisfying the following formula:
0°<θ<45° or 45°<θ<90°.

16. The optical pickup of claim 15, further comprising a quarter wave plate disposed on an optical path between the polarization changer and the polarization hologram element.

17. The optical pickup of claim 15, wherein the light source emits blue light, the first information storage medium is a blu-ray disc, and the second information storage medium is a high-definition digital versatile disc.

18. The optical pickup of claim 15, further comprising:
a low density optical system which emits light suitable for a third information storage medium which has a lower recording density than the first and second information storage media, the low density optical system receiving light reflected by the third information storage medium; and
an optical path coupler which couples an optical path of light emitted from the low density optical system to an optical path of the light emitted from the light source, wherein the optical pickup is compatible with the first, second, and third information storage media, and the third information storage medium is at least one of a digital versatile disc or a compact disc.

19. The optical pickup of claim 18, further comprising an optical element which is interposed between the low density optical system and the objective lens, and which focuses light emitted from the low density optical system onto the third information storage medium by creating a numerical aperture suitable for the third information storage medium.

20. An optical recording and/or reproducing apparatus, comprising:
an optical pickup, comprising:
a light source which emits light,
an objective lens which focuses the light emitted from the light source onto an information storage medium,
a polarization changer which changes the light into light beams with first and second polarizations which are orthogonal to each other,
a polarization hologram element which has a varying refractive power according to the polarization of the first and second light beams,
a photodetector which receives light after the light has been emitted from the light source, focused on the first information storage medium by the objective lens, and reflected by the information storage medium, and
an optical path changer which guides the light reflected by the information storage medium toward the photodetector, wherein the optical pickup is compatible with the first information storage medium and a second information storage medium which has a different thickness from the first information storage medium, wherein the optical pickup is designed to be movable in a radial direction of the information storage media and to record and reproduce information on the information storage medium; and
a control unit which controls movement of the optical pickup.

21. The optical recording and/or reproducing apparatus of claim 20, wherein the polarization changer is a half wave plate.

22. The optical recording and/or reproducing apparatus of claim 20, wherein the polarization changer is disposed between the optical path changer and the objective lens.

23. The optical recording and/or reproducing apparatus of claim 22, wherein the optical path changer is a polarization beam splitter.

24. The optical recording and/or reproducing apparatus of claim 21, wherein the polarization hologram element has a polarization hologram area which directly transmits the light with the first polarization to the objective lens so that the light with the first polarization is focused onto the first information storage medium, and refracts the light with the second polarization to the objective lens so that the light with the second polarization is focused onto the second information storage medium.

25. The optical recording and/or reproducing apparatus of claim 24, wherein the polarization hologram area is formed so that, when the light with the second polarization refracted from the polarization hologram area is transmitted to the objective lens, the polarization hologram area forms a numerical aperture of the objective lens to focus the light with the second polarization onto the second information storage medium.

26. The optical recording and/or reproducing apparatus of claim 25, wherein the light source emits blue light, the first information storage medium is a blu-ray disc, and the second information storage medium is a high-density digital versatile disc.

27. The optical recording and/or reproducing apparatus of claim 20, wherein the polarization hologram element has a polarization hologram area which directly transmits the light with the first polarization to the objective lens so that the light with the first polarization is focused onto the first information storage medium, and refracts the light with the second polarization to the objective lens so that the light with the second polarization is focused onto the second information storage medium.

28. The optical recording and/or reproducing apparatus of claim 27, wherein the polarization hologram area is formed so that, when the light with the other polarization refracted from the polarization hologram area is transmitted to the objective lens, the polarization hologram area forms a numerical aperture to focus the light beam with the second polarization onto the second information storage medium.

29. The optical recording and/or reproducing apparatus of claim 28, wherein the light source emits blue light, the first information storage medium is a blu-ray disc, and the second information storage medium is a high-density digital versatile disc.

30. The optical recording and/or reproducing apparatus of claim 20, wherein the polarization changer is configured so that an optic axis of the polarization changer can range from 0 to 45 degrees or from 45 to 90 degrees with respect to a polarization direction of the light incident from the light source.

31. The optical recording and/or reproducing apparatus of claim 30, further comprising:
a low density optical system which emits light suitable for a third information storage medium which has a lower recording density than the first and second information storage media, the low density optical system receiving light reflected by the third information storage medium; and
an optical path coupler which couples an optical path of light emitted from the low density optical system to an optical path of the light with the first wavelength, wherein the optical pickup is compatible with the first, second, and third information storage media, and the third information storage medium is at least one of a digital versatile disc or a compact disc.

32. The optical recording and/or reproducing apparatus of claim 31, further comprising an optical element which is disposed between the low density optical system and the objective lens, and which focuses light emitted from the low density optical system onto the third information storage medium by creating a numerical aperture suitable for the third information storage medium.

33. The optical recording and/or reproducing apparatus of claim 20, further comprising a driving unit which drives the polarization changer according to the kind of information storage medium used and whether the apparatus is in recording mode or reproduction mode, so that the optic axis of the polarization changer is equal to or orthogonal to the polarization direction of the light incident from the light source, or forms an angle θ with respect to the polarization direction of the light emitted from the light source of 45 degrees, 135 degrees, or satisfying the following formula:
0°<θ<45° or 45°<θ<90°.

34. The optical recording and/or reproducing apparatus of claim 33, further comprising a quarter wave plate disposed on an optical path between the polarization changer and the polarization hologram element.

35. The optical recording and/or reproducing apparatus of claim 33, wherein the light source emits blue light, the first information storage medium is a blu-ray disc, and the second information storage medium is a high-definition digital versatile disc.

36. The optical recording and/or reproducing apparatus of claim 33, further comprising:
a low density optical system which emits light suitable for a third information storage medium which has a lower recording density than the first and second information storage media, the low density optical system receiving light reflected by the third information storage medium; and
an optical path coupler which couples an optical path of light emitted from the low density optical system to an optical path of the light with the first wavelength, wherein the optical pickup is compatible with the first, second, and third information storage media, and the third information storage medium is at least one of a digital versatile disc or a compact disc.

37. The optical recording and/or reproducing apparatus of claim 33, further comprising an optical element which is disposed between the low density optical system and the objective lens, and which focuses light emitted from the low density optical system onto the third information storage medium by creating a numerical aperture suitable for the third information storage medium.

38. An optical system, comprising:
a light source which emits light to read from and/or write selectively onto a first information storage medium and a second information storage medium which is thicker than the first information storage medium;
a single optical lens which focuses the light onto the first and second information storage media;
a polarizing element which polarizes the light into a first polarized light beam and a second polarized light beam; and
a polarization hologram element which is adjusted to refract the second polarized light beam as the second polarized light beam passes through the polarization hologram element to the single optical lens in order to read from and/or write onto the thicker second information storage medium.

39. The optical system of claim 38, wherein the single optical lens is optimized to read from and/or write onto the first information storage medium.

40. The optical system of claim 38, wherein the polarization hologram element directly transmits the first polarized light beam to the single optical lens without refracting the first polarization light beam.

41. An optical recording and/or reproducing apparatus, comprising:
the optical pickup of claim 38, designed to be movable in a radial direction of the first and second information storage media, and to record and/or reproduce information on the first and second information storage media; and
a control unit which controls movement of the optical pickup.

42. A method to focus one wavelength of light onto multiple surfaces at different depths using a single optical lens, comprising:
emitting the light from a light source;
polarizing the light into a first polarized light beam and a second polarized light beam orthogonal to the first polarized light beam;
directly transmitting the first polarized light beam through an outer numerical aperture of a polarization hologram element to focus the first polarized light beam at one depth; and
refracting the second polarized light beam through an inner numerical aperture of a polarization hologram element to focus the second polarized light beam at another depth, wherein the inner numerical aperture comprises an adjustable polarization hologram area which is adjusted to refract the second polarized light beam onto the single optical lens at a desired position.
